(19) United States
(12) Patent Application Publication
(10) Pub. No.: US 2026/0167425 A1
(43) Pub. Date: Jun. 18, 2026

(54) EQUIPMENT AND METHODS TO SUPPORT THE PICK-UP AND UNLOADING OF GOODS BY TRAILERS AND AUTOMATED GUIDED VEHICLES

(71) Applicant: ALLY LOGISTIC PROPERTY CO., LTD., Taipei City (TW)

(72) Inventors: CHIEN-TAI CHANG, Taipei City (TW); PEI-CHIA LIU, Taipei City (TW); KAI-LUN LIN, Taipei City (TW); YU-CHEN KUO, Taipei City (TW); CHI-HAO WANG, Taipei City (TW)

(21) Appl. No.: 19/232,928

(22) Filed: Jun. 10, 2025

(30) Foreign Application Priority Data
Dec. 12, 2024 (TW) 113148308

(51) Int. Cl. B65G 1/137; B66F 9/06; B66F 9/075

(52) U.S. Cl. CPC B65G 1/1373; B66F 9/063; B66F 9/0755

(57) ABSTRACT

An equipment includes an inbound area having an inbound position and a preset position, a cargo detection device disposed in the inbound area for detecting the cargo at the inbound position, a cargo lifting device disposed in the inbound area, a cargo moving device disposed in adjacent to the cargo lifting device, and an outbound area disposed in adjacent to the inbound area. When the cargo is at the inbound position, the cargo lifting device lifts the cargo from the inbound position to the preset position. When the cargo is at the preset position, the cargo moving device receives the cargo at the preset position and outputs the cargo along an inbound direction. The outbound area receives the cargo and outputs it to an automated guided vehicle.

### BACKGROUND OF THE DISCLOSURE

### 1. Field of the Disclosure

The present disclosure relates to equipment, and more particularly, to an equipment and methods to support the pick-up and unloading of goods by trailers and automated guided vehicles.

### 2. Description of the Related Art

An automated guided vehicle (AGV) is a type of robot for transporting goods in an unmanned environment. Specifically, the AGV is able to automatically navigate along a predetermined path and load or unload goods in order to achieve intelligent arrangement purpose, effectively moving goods between various workstations.

However, in conventional goods transporting operation performed by an AGV, usage of a support frame is required to elevate the goods for creating a height difference between the goods and the ground, facilitating the movement of goods by the AGV. In addition, staff need to first operate machinery to place the goods onto the support frame, such that the AGV is allowed to successfully transport the goods.

On the other hand, currently in the market, there is no technology which is able to integrate multiple detection functions into the workstation to support the loading and unloading of goods by trailers and AGVs.

Therefore, it is desirable for the industry to develop a technological solution to address the aforementioned issues in order to improve the shortcomings of existing technologies.

### SUMMARY OF THE DISCLOSURE

The present disclosure aims at providing an equipment and methods to support the pick-up and unloading of goods by trailers and automated guided vehicles.

The aforementioned objectives do not prevent the existence of other objectives. Those objectives derivable from the specification, claims, or drawings of the present disclosure by a person having ordinary skill in the field of the invention are also included in the scope of objectives of the present disclosure. Therefore, the objectives of the present disclosure are not limited to the aforementioned objectives.

For achieving the aforementioned objectives, the present disclosure provides an equipment to support the pick-up and unloading of goods by trailers and automated guided vehicles, comprising:
an inbound area having an inbound position and a preset position, the inbound position used for receiving a cargo, the preset position arranged on a top side of the inbound position;
a cargo detection device disposed in the inbound area for detecting the cargo at the inbound position;
a cargo lifting device disposed in the inbound area for lifting the cargo; when the cargo detection device detects the cargo at the inbound position, the cargo lifting device lifts the cargo from the inbound position to the preset position;
a cargo moving device disposed in adjacent to the cargo lifting device for moving the cargo; when the cargo is at the preset position, the cargo moving device moves to the inbound position and receives the cargo at the preset position, and the cargo moving device outputs the cargo along an inbound direction; and
an outbound area disposed in adjacent to the inbound area for receiving the cargo moved by the cargo moving device, such that the cargo is output to an automated guided vehicle.

In an embodiment, the present disclosure provides a method to support the pick-up and unloading of goods by trailers and automated guided vehicles, comprising:
inputting a cargo to an inbound position of an inbound area;
detecting the cargo at the inbound position using a cargo detection device, and detecting a machinery in proximity to the inbound area using a machinery detection device;
when the cargo detection device detects the cargo at the inbound position and the machinery detection device does not detect a machinery, a pallet detection device detects a width of a pallet of the cargo; when the width does not match a preset width, the pallet detection device sends a width abnormality signal to a warehouse control system, and the warehouse control system sends the width error signal to a monitoring device;
when the cargo deviates from the inbound position, a pallet alignment device is used to push the pallet to the inbound position;
detecting a weight of the cargo at the inbound position using a weight detection device; when the weight does not match a preset weight, the weight detection device sends a weight error signal to the warehouse control system, the warehouse control system sends the weight error signal to the monitoring device; detecting a volume of the cargo at the inbound position using a volume detection device; when the volume does not match a preset volume, the volume detection device sends a volume error signal to the warehouse control system, and the warehouse control system sends the volume error signal to the monitoring device; reading a label information on the cargo at the inbound position using a cargo identification device; when the label information does not match a cargo information, the cargo identification device sends a label error signal to the warehouse control system, and the warehouse control system sends the label error signal to the monitoring device;
when the weight, the volume, and the label information of the cargo match the preset weight, the preset volume, and the cargo information, a cargo lifting device lifts the cargo from the inbound position to a preset position of the inbound area; and
when the cargo is at the preset position, a cargo moving device moves to the inbound position and receives the cargo at the preset position, and the cargo moving device outputs the cargo along an inbound direction to an automated guided vehicle.

In an embodiment, the present disclosure provides a method to support the pick-up and unloading of goods by trailers and automated guided vehicles, comprising:
detecting whether there is an foreign object in an outbound area using a foreign object detection device; when the foreign object detection device does not detect a foreign object in the inbound area, a warehouse control system sends a permission signal to an automated guided vehicle for allowing the automated guided vehicle to enter the inbound area, and the automated guided vehicle places a cargo on a cargo lifting device;
reading a label information on the cargo in the outbound area using a cargo identification device, and displaying the label information on a monitoring device; and
when the label information matches a cargo information, a cargo lifting device moves the cargo along a Z-axis direction to an outbound position of the outbound area.

With such configuration, the present disclosure achieves following advantages.

Through the collaborative operation of different devices, the present disclosure lifts the cargo to a certain height, allowing the automated guided vehicle to take over the cargo, so as to efficiently output the cargo.

Also, in addition to placing the cargo onto the AGV, the present disclosure integrates various detection functions, such as detecting the weight, volume, and information of the cargo, thereby enhancing the functionality of equipment.

Furthermore, the equipment not only supports an inbound mode but also provides an outbound mode, facilitating the handling operations of the AGV, thereby significantly increasing the practicality of the equipment.

### BRIEF DESCRIPTION OF THE DRAWINGS

FIG. 1 is a perspective view of the equipment in accordance with an embodiment of the present disclosure, illustrating the appearance features of the equipment.

FIG. 2 is a side view of the equipment in accordance with an embodiment of the present disclosure, illustrating the lateral sides of the inbound area and the outbound area.

FIG. 3 is another side view of the equipment in accordance with an embodiment of the present disclosure, illustrating the arrangement of the inbound area and various objects.

FIG. 4 is a schematic view of the equipment in accordance with an embodiment of the present disclosure, illustrating the cargo received in the inbound area.

FIG. 5 is another schematic view of the equipment in accordance with an embodiment of the present disclosure, illustrating the cargo at the inbound position.

FIG. 6 is another schematic view of the equipment in accordance with an embodiment of the present disclosure, illustrating the cargo being lifted from the inbound position to the preset position.

FIG. 7 is another schematic view of the equipment in accordance with an embodiment of the present disclosure, illustrating the cargo outputted from the outbound area.

FIG. 8 is a structural block view of the equipment in accordance with an embodiment of the present disclosure, illustrating the coupling relationship between the objects of the equipment.

FIG. 9 is a flow chart of the method in accordance with an embodiment of the present disclosure.

FIG. 10 is another perspective view of the equipment in accordance with an embodiment of the present disclosure, illustrating the outbound mode of the equipment.

FIG. 11 is a flow chart of the method in accordance with another embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

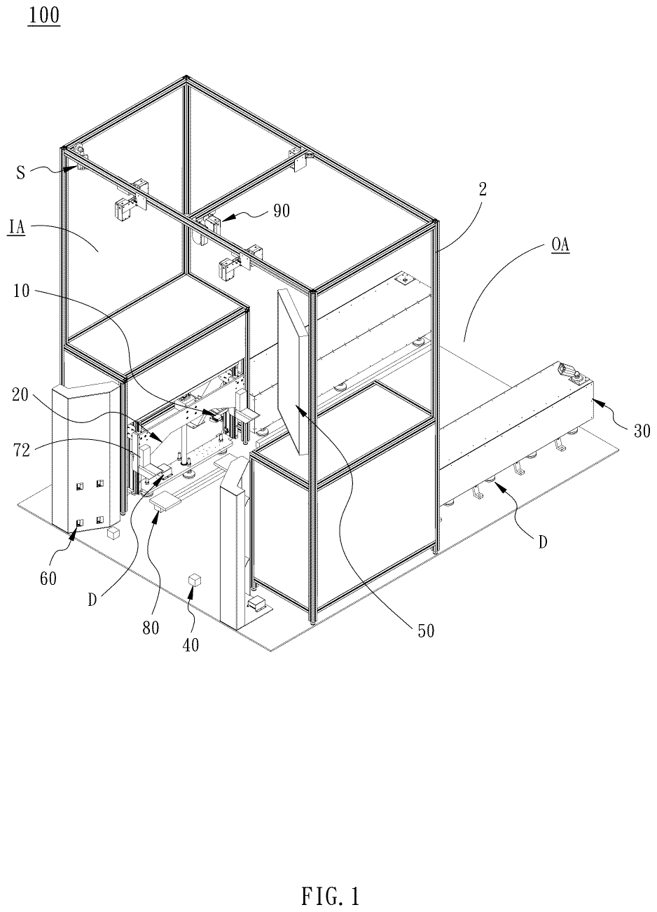

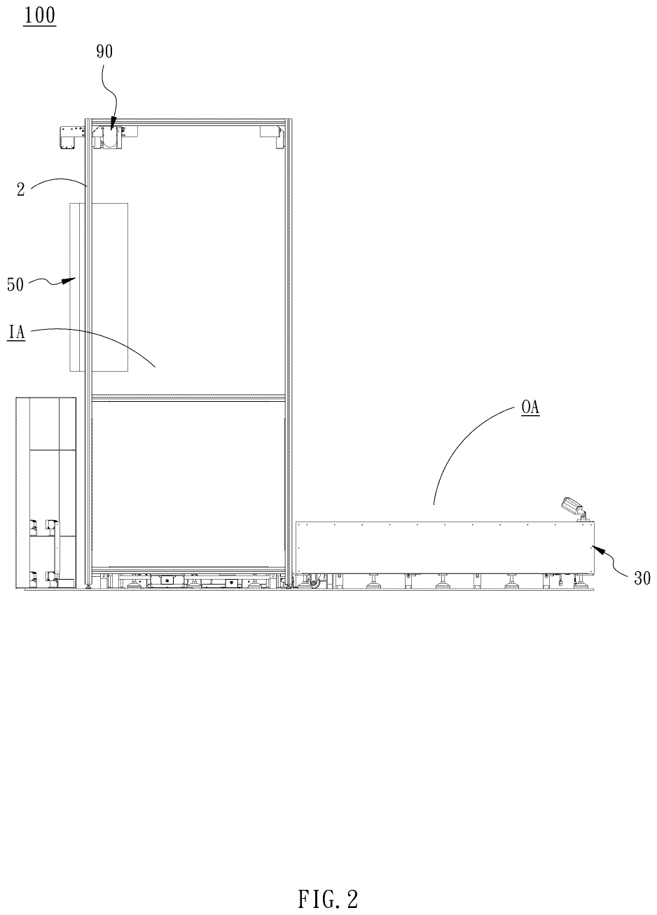

Referring to FIG. 1 to FIG. 8, in an embodiment, the present disclosure provides an equipment 100 for supporting the pick-up and unloading of cargo 1 by trailers and automated guided vehicles, achieving the purpose of full automation.

Referring to FIG. 1 to FIG. 4, the equipment 100 comprises an inbound area IA, a cargo detection device 10, a cargo lifting device 20, a cargo moving device 30, and an outbound area OA.

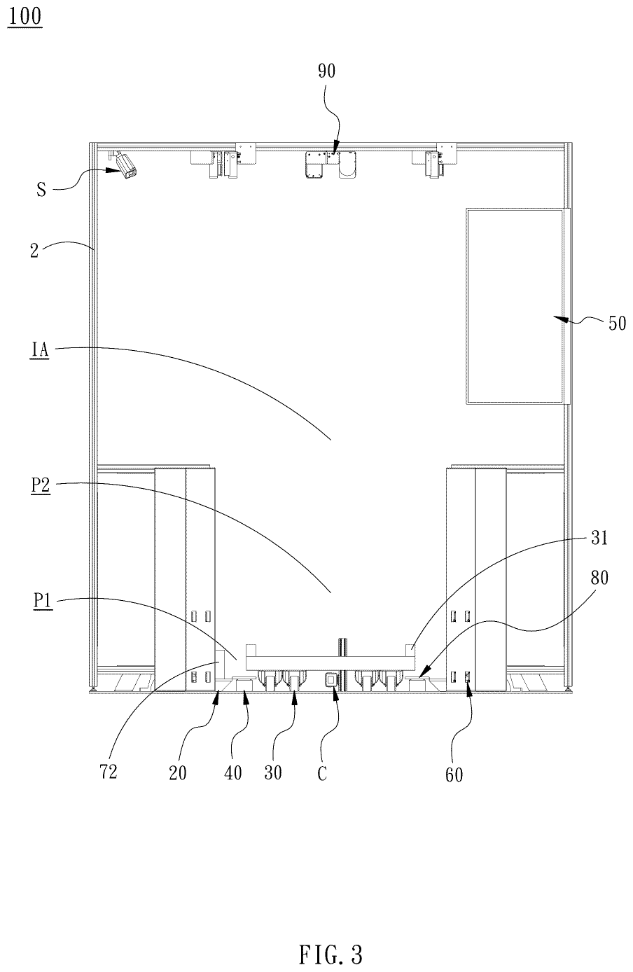

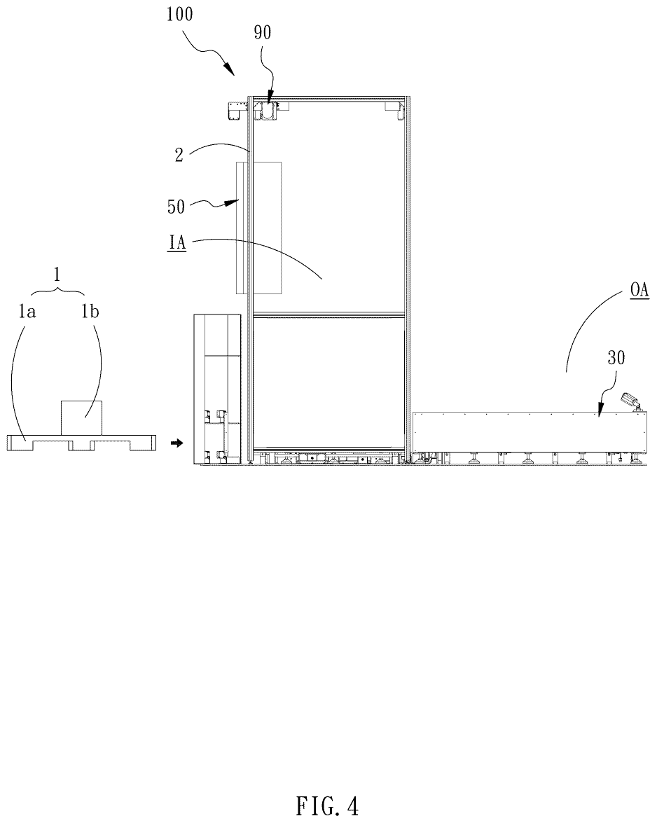

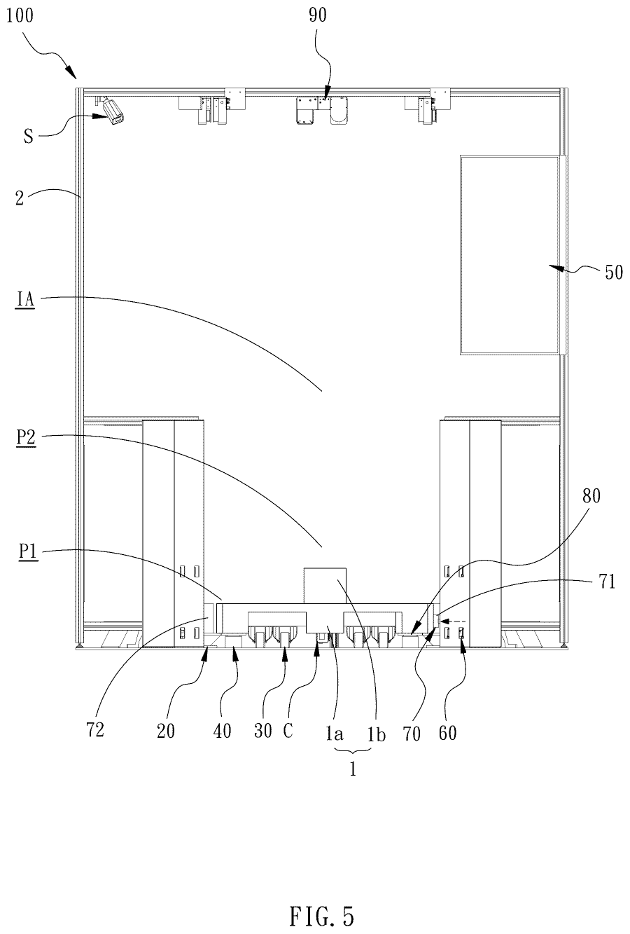

Referring to FIG. 3, the inbound area IA has an inbound position P1 and a preset position P2. Referring to FIG. 4 and FIG. 5, the inbound area P1 is used for receiving a cargo 1. The preset position P2 is arranged on the top side of the inbound position P1. Also, the inbound area IA has a support frame 2, on which the device is mounted.

The cargo detection device 10 is disposed in the inbound area IA. In the embodiment, the cargo detection device 10 is disposed on the support frame 2. The cargo detection device 10 is configured to detect the cargo 1 at the inbound position P1; in other words, the cargo detection device 10 is used for detecting if the cargo 1 is at the inbound position P1.

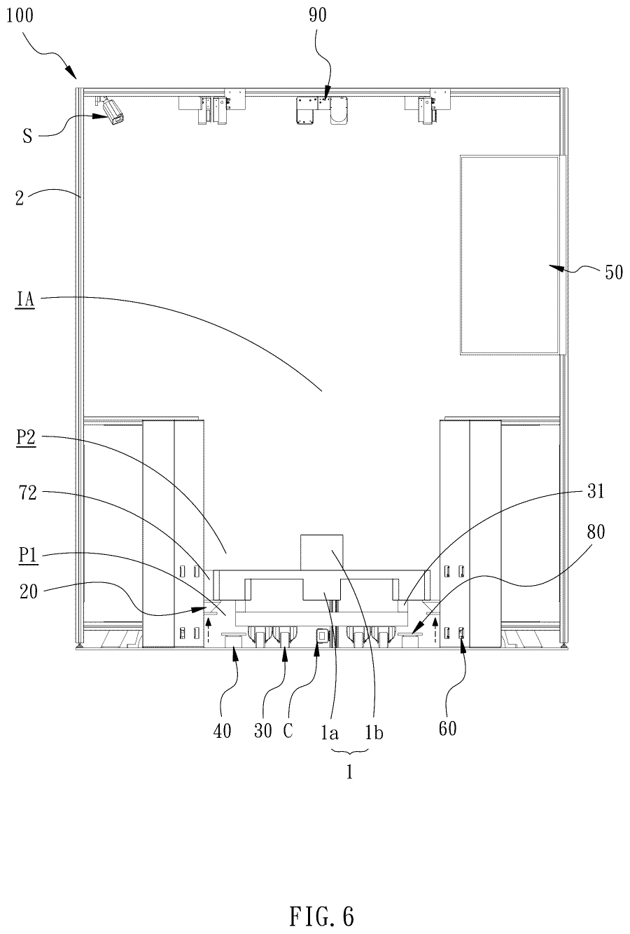

The cargo lifting device 20 is disposed in the inbound area IA. The cargo lifting device 20 is configured to lift the cargo 1. Referring to FIG. 5 and FIG. 6, when the cargo detection device 10 detects the cargo 1 at the inbound position P1, the cargo lifting device 20 lifts the cargo 1 from the inbound position P1 to the preset position P2, so that the cargo 1 is in alignment with the height of the automated guided vehicle AGV.

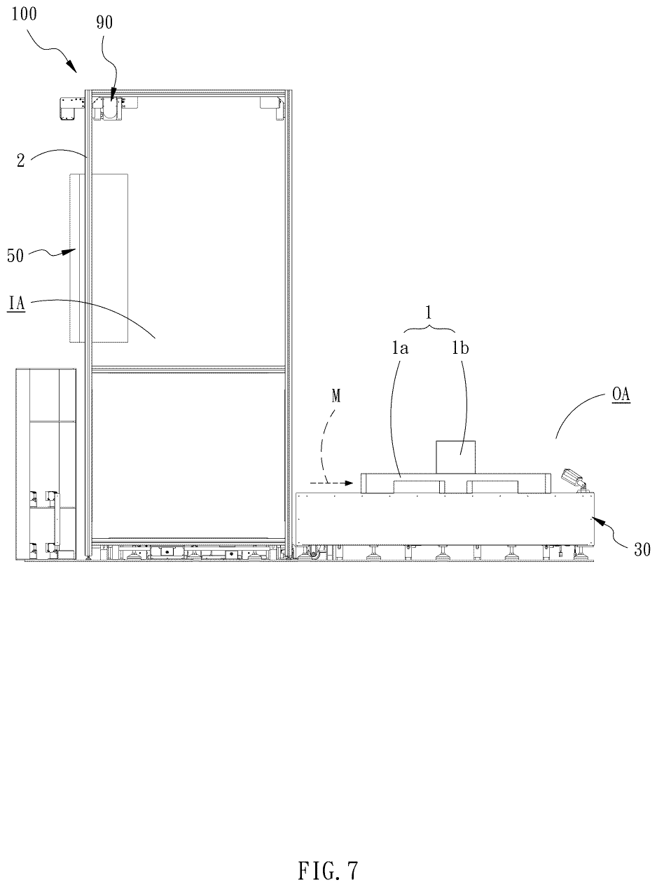

The cargo moving device 30 is disposed in adjacent to the cargo lifting device 20. The cargo moving device 30 is configured to move the cargo 1. Referring to FIG. 6, when the cargo 1 is at the preset position P2, the cargo moving device 30 moves to the inbound position P1 and receives the cargo 1 at the preset position P2. For example, the cargo moving device 30 has a receiving module 31 extending from one side of the cargo lifting device 20, and the receiving module 31 moves to the inbound position P1 below the preset position P2 to receive the cargo 1. Referring to FIG. 7, the cargo moving device 30 outputs the cargo 1 along an inbound direction M.

The outbound area OA is disposed in adjacent to the inbound area IA. The outbound area OA receives the cargo 1 moved by the cargo moving device 30, so as to output the cargo 1. Accordingly, the automated guided vehicle AGV is allowed to enter the outbound area OA to receive the cargo 1 in the outbound area OA.

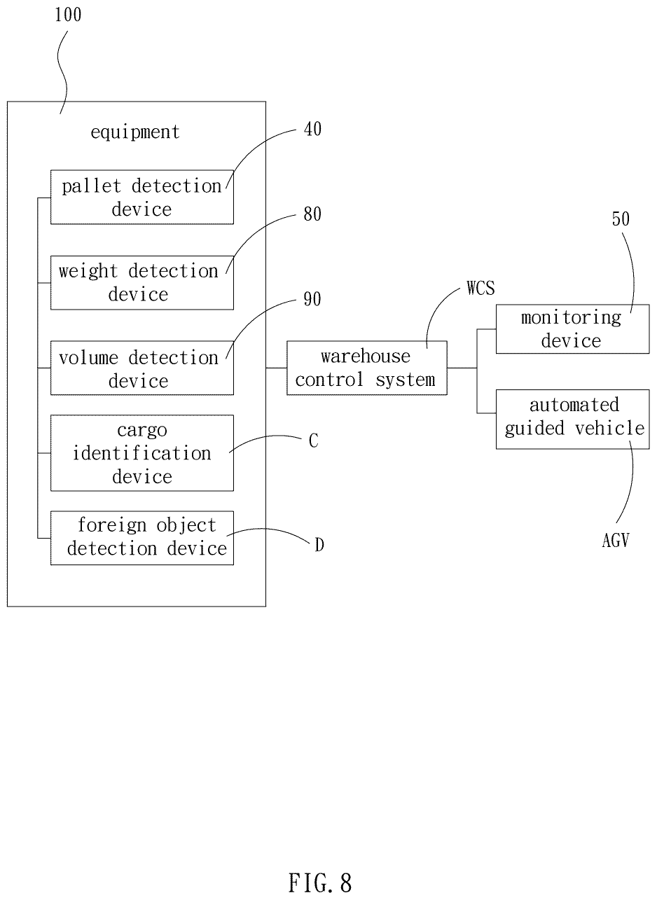

Referring to FIG. 8, to improve the functionality of the equipment 100, the equipment 100 further comprises a pallet detection device 40 and a monitoring device 50. The pallet detection device 40 is coupled with the monitoring device 50. The monitoring device 50 is allowed to be disposed in the inbound area IA. The cargo 1 comprises a pallet 1a holding a storage item 1b thereon. The pallet detection device 40 is configured to detect the width of the pallet 1a at the inbound position P1. When the width does not match a preset width, the pallet detection device 40 sends a width error signal to a warehouse control system WCS, and the warehouse control system WCS sends the width error signal to the monitoring device 50 to notify on-site staff.

In an embodiment, to prevent machinery near the equipment 100 from affecting the operation of the equipment 100, the equipment 100 further comprises a machinery detection device 60. The machinery detection device 60 is disposed in the inbound area IA and configured to detect any machinery near the inbound area IA. Therein, the machinery device 60 detects machinery through an infrared technology. When the machinery detection device 60 does not detect any machinery nearby, the pallet detection device 40 carries out the detection of the width of the pallet 1a.

To prevent the positional deviation of the cargo 1 from affecting the operation of devices, the equipment 100 further comprises a pallet alignment device 70. The pallet alignment device 70 is disposed in the inbound area IA, and configured to align the position of the cargo 1. When the cargo 1 deviates from the inbound position P1, the pallet alignment device 70 pushes the pallet 1a to the inbound position P1.

In the embodiment, the pallet alignment device 70 comprises a push rod 71 and an abutment portion 72. The push rod 71 is disposed in the inbound area IA and arranged on one side of the cargo moving device 30. The abutment portion 72 is disposed in the inbound area IA and arranged on the same side of the cargo moving device 30 with the push rod 71, wherein the abutment portion 72 and the push rod 71 are disposed in opposite to each other. Therein, the abutment portion 72 is disposed on the cargo lifting device 20, so as to ascend and descend together along with the cargo lifting device 20. When the cargo 1 deviates from the inbound position P1, the push rod 71 pushes the cargo 1 to the inbound position P1, such that the cargo 1 abuts against the abutment portion 72, whereby the position of the cargo 1 is aligned.

The equipment 100 further comprises a weight detection device 80. The weight detection device 80 is disposed in the inbound area IA. Therein, the weight detection device 80 is disposed on the bottom side of the inbound area IA and coupled with the monitoring device 50. The weight detection device 80 is configured to detect a weight of the cargo 1 at the inbound position P1. When the weight does not match a preset weight, the weight detection device 80 sends a weight error signal to the warehouse control system WCS, and the warehouse control system WCS sends the weight error signal to the monitoring device 50 to notify on-site staff.

The equipment 100 further comprises a volume detection device 90. The volume detection device 90 is allowed to be disposed in the inbound area IA. The volume detection device 90 is coupled with the monitoring device 50. The volume detection device 90 is configured to detect a volume of the cargo 1 at the inbound position P1. Therein, the volume detection device 90 detects the volume of the cargo through an optical inspection technology. When the volume does not match a preset volume, the volume detection device 90 sends a volume error signal to the warehouse control system WCS, and the warehouse control system WCS sends the volume error signal to the monitoring device 50 to notify on-site staff.

The equipment 100 further comprises a cargo identification device C. The cargo identification device C is allowed to be disposed in the inbound area IA. The cargo identification device C is coupled with the monitoring device 50. The cargo identification device C is configured to read a label information on the cargo 1 at the inbound position P1. Therein, the cargo identification device C reads the label information of the cargo through a barcode recognition technology and radio frequency identification (RFID) technology. When the label information does not match a cargo information, the cargo identification device C sends a label error signal to the warehouse control system WCS, and the warehouse control system WCS sends the label error signal to the monitoring device 50 to notify on-site staff.

The equipment 100 further comprises a foreign object detection device D. The foreign object detection device D is allowed to be disposed in the inbound area IA and the outbound area OA. The foreign object detection device D is configured to detect whether there is a foreign object in the inbound area IA or the outbound area OA. Therein, the foreign object detection device D detects the existence of a foreign object through an infrared technology. When the foreign object detection device D does not detect any foreign object in the outbound area OA, the warehouse control system WCS sends a permission signal to the automated guided vehicle AGV, allowing the automated guided vehicle AGV to enter the outbound area OA. In an embodiment, when there is no foreign object below the outbound area OA, the automated guided vehicle AGV accordingly enters the outbound area OA.

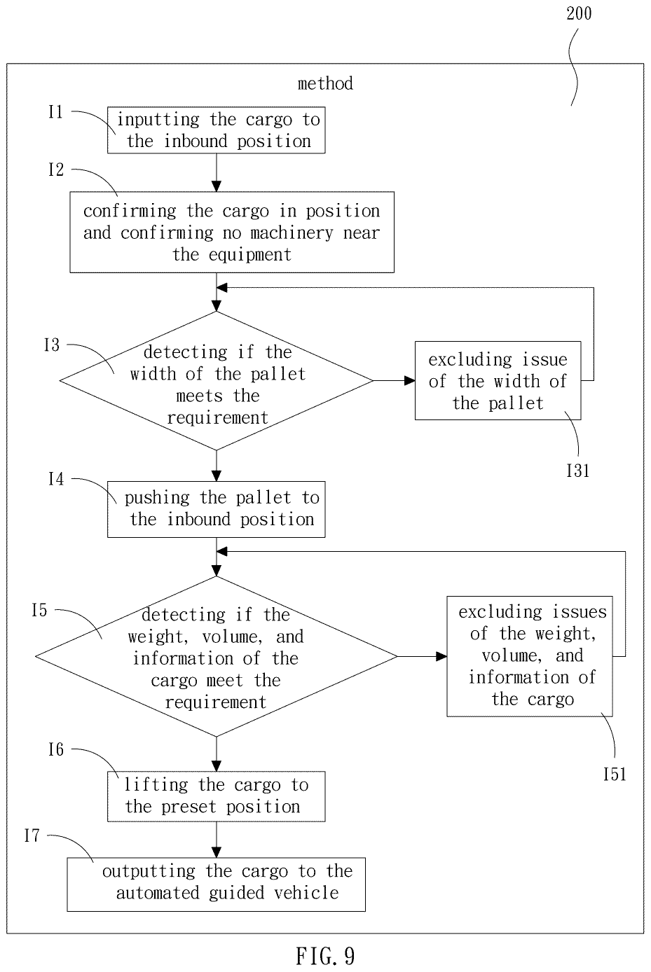

Referring to FIG. 9, in an embodiment, the present disclosure provides a method 200 to support the loading and unloading of goods by trailers and automated guided vehicles, comprising following steps.

In step I1, a cargo 1 is input to an inbound position P1 of an inbound area IA.

In step I2, a cargo detection device 10 is used to detect the cargo 1 at the inbound position P1, and a machinery detection device 60 is used to detect machinery near the inbound area IA. Accordingly, the cargo 1 is in position, and the absence of machinery near equipment 100 is confirmed.

In step I3, when the cargo detection device 10 detects the cargo 1 at the inbound position P1 and the machinery detection device 60 does not detect any machinery nearby, a pallet detection device 40 is used to detect the width of the pallet 1a of the cargo 1, so as to confirm if the width of the pallet 1a meets the required width standard. If the width does not match a preset width, the pallet detection device 40 sends a width error signal to a warehouse control system WCS, and the warehouse control system WCS sends the width error signal to a monitoring device 50 to notify on-site staff. In step I31, when the width issue of the pallet 1a is resolved, the pallet detection device 40 is used to detect the width of the pallet 1a again. If the width of the pallet 1a meets the requirement, the equipment 100 continues the inbound operation.

In step I4, when the cargo 1 deviates from the inbound position P1, a pallet alignment device 70 pushes the pallet 1a to the inbound position P1. In another embodiment, when the pallet alignment device 70 fails to align the position of the pallet 1a, the pallet alignment device 70 sends an alignment error signal to the warehouse control system WCS, and the warehouse control system WCS sends the alignment signal to the monitoring device 50.

In step I5, a weight detection device 80 is used to detect a weight of the cargo 1 at the inbound position P1. When the weight does not match a preset weight, the weight detection device 80 sends a weight error signal to the warehouse control system WCS, and the warehouse control system WCS sends the weight error signal to the monitoring device 50. In step I51, when the on-site staff resolve the weight issue of the cargo 1, the weight detection device 80 detects the weight of the cargo 1 again. If the weight of the cargo 1 meets the requirement standard, the equipment 100 continues the inbound operation.

In step I5, a volume detection device 90 is used to detect a volume of the cargo 1 at the inbound position P1. When the volume does not match a preset volume, the volume detection device 90 sends a volume error signal to the warehouse control system WCS, and the warehouse control system WCS sends the volume error signal to the monitoring device 50. In step I51, when the on-site staff resolve the volume issue of the cargo 1, the volume detection device 90 detects the volume of the cargo 1 again. If the volume of the cargo 1 meets the requirement standard, the equipment 100 continues the inbound operation.

In step I5, a cargo identification device C reads a label information on the cargo 1 at the inbound position P1. When the label information does not match a cargo information, the cargo identification device C sends a label error signal to the warehouse control system WCS, and the warehouse control system WCS sends the label error signal to the monitoring device 50. In step I51, when the on-site staff resolve the correctness issue of the cargo 1, the cargo identification device C detects the label information of the cargo 1 again. If the label information matches the cargo information, the equipment 100 continues the inbound operation.

In step I6, when the weight, the volume, and the label information of the cargo 1 match the preset weight, the preset volume, and the cargo information, a cargo lifting device 20 lifts the cargo 1 from the inbound position P1 to a preset position P2 of the inbound area IA.

In step I7, when the cargo 1 is at the preset position P2, a cargo moving device 30 moves to the inbound position P1 and receives the cargo 1 at the preset position P2, and the cargo moving device 30 outputs the cargo 1 along an inbound direction M to an automated guided vehicle AGV. In an embodiment, a camera device S is further included, so that the present disclosure records the status of the cargo 1 using the camera device S.

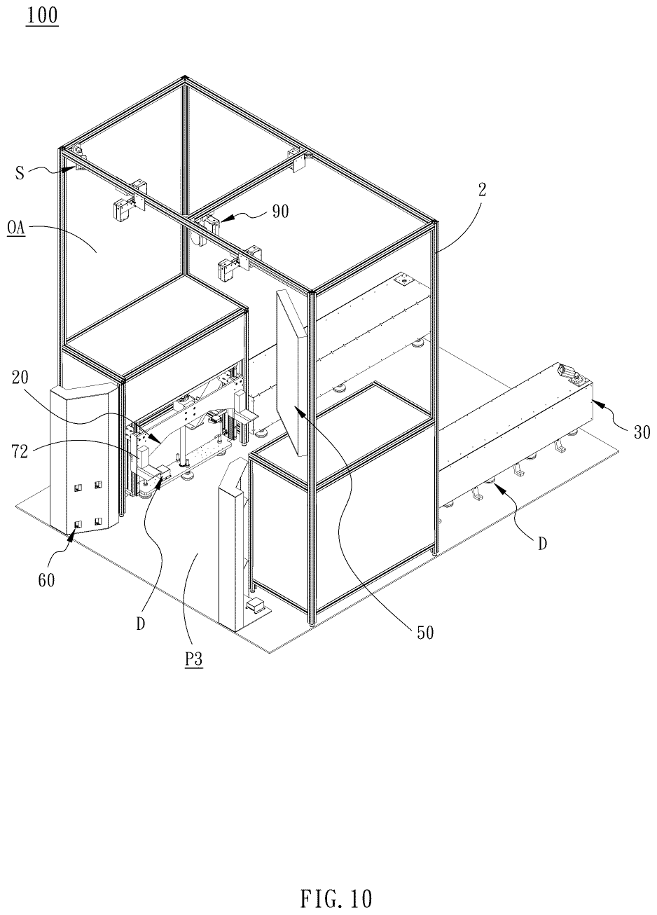

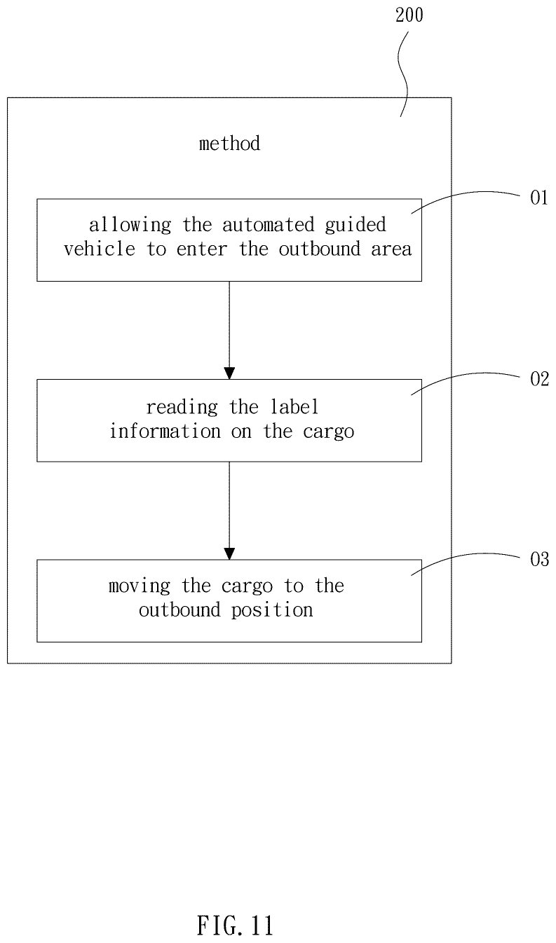

Referring to FIG. 10, in an embodiment, the equipment 100 has an outbound mode. Referring to FIG. 11, the present disclosure provides a method 200 to support the loading and unloading of goods by trailers and automated guided vehicles, comprising following steps.

In step O1, a foreign object detection device D is used to detect whether there is a foreign object in the outbound area OA. When the foreign object detection device D does not detect any foreign object in the outbound area OA, a warehouse control system WCS sends a permission signal to an automated guided vehicle AGV, allowing the automated guided vehicle AGV to enter the outbound area OA, such that the automated guided vehicle AGV places a cargo 1 on a cargo lifting device 20.

In step O2, a cargo identification device C is used to read a label information on the cargo 1 in the outbound area OA, and display the label information on the monitoring device 50, facilitating the monitoring operation of staff.

In step O3, when the label information matches a cargo information, a cargo lifting device 20 moves the cargo 1 along a Z-axis direction to an outbound position P3 of the outbound area OA.

With the foregoing configuration, advantages of the present disclosure will be illustrated below.

Through the collaborative operation of different devices, the present disclosure lifts the cargo 1 to a certain height, allowing the automated guided vehicle AGV to take over the cargo 1, so as to efficiently output the cargo 1.

Also, the equipment 100 of the present disclosure integrates various detection functions, such as detecting the weight, volume, and information of the cargo 1, thereby enhancing the functionality of equipment 100.

Furthermore, the equipment 100 not only supports an inbound mode but also provides an outbound mode, facilitating the handling operations of the automated guided vehicle AGV, thereby significantly increasing the practicality of the equipment.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. An equipment to support the pick-up and unloading of goods by trailers and automated guided vehicles, comprising:
an inbound area having an inbound position and a preset position, the inbound position used for receiving a cargo, the preset position arranged on a top side of the inbound position;
a cargo detection device disposed in the inbound area for detecting the cargo at the inbound position;
a cargo lifting device disposed in the inbound area for lifting the cargo; when the cargo detection device detects the cargo at the inbound position, the cargo lifting device lifts the cargo from the inbound position to the preset position;
a cargo moving device disposed in adjacent to the cargo lifting device for moving the cargo; when the cargo is at the preset position, the cargo moving device moves to the inbound position and receives the cargo at the preset position, and the cargo moving device outputs the cargo along an inbound direction; and
an outbound area disposed in adjacent to the inbound area for receiving the cargo moved by the cargo moving device, such that the cargo is output to an automated guided vehicle.

2. The equipment to support the pick-up and unloading of goods by trailers and automated guided vehicles of claim 1, wherein the equipment comprises a pallet detection device and a monitoring device; the pallet detection device is coupled with the monitoring device; the cargo comprises a pallet; the pallet detection device is configured to detect a width of the pallet at the inbound position; when the width does not match a preset width, the pallet detection device sends a width error signal to a warehouse control system, and the warehouse control system sends the width error signal to the monitoring device.

3. The equipment to support the pick-up and unloading of goods by trailers and automated guided vehicles of claim 2, wherein the equipment comprises a machinery detection device; the machinery detection device is disposed in the inbound area; the machinery detection device is configured to detect a machinery in proximity to the inbound area; when the machinery detection device does not detect a machinery, the pallet detection device detects the width of the pallet.

4. The equipment to support the pick-up and unloading of goods by trailers and automated guided vehicles of claim 3, wherein the equipment comprises a pallet alignment device; the pallet alignment device is disposed in the inbound area; the pallet alignment device is configured to align a position of the cargo; when the cargo deviates from the inbound position, the pallet alignment device pushes the pallet to the inbound position.

5. The equipment to support the pick-up and unloading of goods by trailers and automated guided vehicles of claim 4, wherein the equipment comprises a weight detection device; the weight detection device is disposed in the inbound area; the weight detection device is coupled with the monitoring device; the weight detection device is configured to detect a weight of the cargo at the inbound position; when the weight does not match a preset weight, the weight detection device sends a weight error signal to the warehouse control system, and the warehouse control system sends the weight error signal to the monitoring device.

6. The equipment to support the pick-up and unloading of goods by trailers and automated guided vehicles of claim 5, wherein the equipment comprises a volume detection device; the volume detection device is coupled with the monitoring device; the volume detection device is configured to detect a volume of the cargo at the inbound position; when the volume does not match a preset volume, the volume detection device sends a volume error signal to the warehouse control system, and the warehouse control system sends the volume error signal to the monitoring device.

7. The equipment to support the pick-up and unloading of goods by trailers and automated guided vehicles of claim 6, wherein the equipment comprises a cargo identification device; the cargo identification device is coupled with the monitoring device; the cargo identification device is configured to read a label information on the cargo at the inbound position; when the label information does not match a cargo information, the cargo identification device sends a label error signal to the warehouse control system, and the warehouse control system sends the label error signal to the monitoring device.

8. The equipment to support the pick-up and unloading of goods by trailers and automated guided vehicles of claim 7, wherein the equipment comprises a foreign object detection device; the foreign object detection device is coupled with an automated guided vehicle; the foreign object detection device is configured to detect whether there is a foreign object in the outbound area; when the foreign object detection device does not detect a foreign object in the outbound area, the warehouse control system sends a permission signal to the automated guided vehicle, allowing the automated guided vehicle to enter the outbound area.

9. A method to support the pick-up and unloading of goods by trailers and automated guided vehicles, comprising:
inputting a cargo to an inbound position of an inbound area;
detecting the cargo at the inbound position using a cargo detection device, and detecting a machinery in proximity to the inbound area using a machinery detection device;
when the cargo detection device detects the cargo at the inbound position and the machinery detection device does not detect a machinery, a pallet detection device detects a width of a pallet of the cargo; when the width does not match a preset width, the pallet detection device sends a width abnormality signal to a warehouse control system, and the warehouse control system sends the width error signal to a monitoring device;
when the cargo deviates from the inbound position, a pallet alignment device is used to push the pallet to the inbound position;
detecting a weight of the cargo at the inbound position using a weight detection device; when the weight does not match a preset weight, the weight detection device sends a weight error signal to the warehouse control system, the warehouse control system sends the weight error signal to the monitoring device; detecting a volume of the cargo at the inbound position using a volume detection device; when the volume does not match a preset volume, the volume detection device sends a volume error signal to the warehouse control system, and the warehouse control system sends the volume error signal to the monitoring device; reading a label information on the cargo at the inbound position using a cargo identification device; when the label information does not match a cargo information, the cargo identification device sends a label error signal to the warehouse control system, and the warehouse control system sends the label error signal to the monitoring device;
when the weight, the volume, and the label information of the cargo match the preset weight, the preset volume, and the cargo information, a cargo lifting device lifts the cargo from the inbound position to a preset position of the inbound area; and
when the cargo is at the preset position, a cargo moving device moves to the inbound position and receives the cargo at the preset position, and the cargo moving device outputs the cargo along an inbound direction to an automated guided vehicle.

10. A method to support the pick-up and unloading of goods by trailers and automated guided vehicles, comprising:
detecting whether there is an foreign object in an outbound area using a foreign object detection device; when the foreign object detection device does not detect a foreign object in the outbound area, a warehouse control system sends a permission signal to an automated guided vehicle for allowing the automated guided vehicle to enter the outbound area, and the automated guided vehicle places a cargo on a cargo lifting device;
reading a label information on the cargo in the outbound area using a cargo identification device, and displaying the label information on a monitoring device; and
when the label information matches a cargo information, a cargo lifting device moves the cargo along a Z-axis direction to an outbound position of the outbound area.
